(19) United States
(12) Patent Application Publication
(10) Pub. No.: US 2022/0212042 A1
(43) Pub. Date: Jul. 7, 2022

(54) MASK-ORIENTED AIR FILTERING PAD

(71) Applicant: NATIONAL TAIWAN OCEAN UNIVERSITY, Keelung City (TW)

(72) Inventor: Jian HUA, Keelung City (TW)

(21) Appl. No.: 17/169,531

(22) Filed: Feb. 7, 2021

(30) Foreign Application Priority Data
Jan. 7, 2021 (TW) 110100615

(51) Int. Cl. A62B 23/02

(52) U.S. Cl. CPC A62B 23/025

(57) ABSTRACT

A mask-oriented air filtering pad includes a base layer, a filtering layer, an airtight seal and at least two connection elements. The base layer has an outer side and an inner side. The filtering layer is disposed at the middle of the inner side. The filtering layer corresponds in outline to the human mouth and nose. The airtight seal surrounds the filtering layer and is disposed on the inner side. The at least two connection elements are disposed at two end portions on the outer side, respectively. The required area of the filtering layer is minimized, and the airtight seal tightly encloses the human mouth and nose; thus, the mask-oriented air filtering pad can save filtering materials, cut cost, reduce waste, enhance filtration, and allow the human face to feel comfortable.

### CROSS-REFERENCE TO RELATED APPLICATION

This non-provisional application claims priority under 35 U.S.C. § 119(a) on Patent Application No(s).110100615 filed in Taiwan, R.O.C. on Jan. 7, 2021, the entire contents of which are hereby incorporated by reference.

### BACKGROUND OF THE INVENTION

### 1. Field of the Invention

The present disclosure relates to an air filtering device coupled to a mask, and in particular to a mask-oriented air filtering pad coupled to any mask, including a conventional face mask.

### 2. Description of the Related Art

Conventional, existing face masks or masks come in different purposes and grades, such as surgical face masks, N95 face masks, dust particle face masks, and toxin filtering face masks/masks, which users select to use as needed. Existing face masks contain filtering material and are mounted on the human ears with cords to fully cover the human nose and mouth with a view to filtering out airborne pollutants.

However, the coverage of the existing face masks extends beyond the human mouth and nose, but the filtering material contained in the redundant parts of the existing face masks is useless and thus constitutes a waste of material. Furthermore, the redundant parts of the existing face masks not only overheat the human face but also cause discomfort to the human ears. Furthermore, the existing face masks are not visually attractive, because of limitations on shape and material. In addition, despite the cords and nose bridge strips, edges of the existing face masks seldom fit tightly to the human face, and thus air can still be admitted to the detriment of filtration efficiency.

### BRIEF SUMMARY OF THE INVENTION

An objective of the present disclosure is to provide a mask-oriented air filtering pad coupled to a mask or facial veil of any pattern.

To achieve at least the above objective, the present disclosure provides a mask-oriented air filtering pad, comprising: a base layer having an outer side and an inner side; a filtering layer disposed at the middle of the inner side and corresponding in outline to the human mouth and nose; an airtight seal surrounding the filtering layer and disposed on the inner side; and at least two connection elements disposed at two end portions on the outer side, respectively.

In an embodiment of the present disclosure, a distance between the two end portions of the base layer is greater than a width of a middle part of the base layer.

In an embodiment of the present disclosure, the at least two connection elements are adhesive.

In an embodiment of the present disclosure the shape of the filtering layer tapers upward, whereas the two connection elements are disposed at left and right edges of the filtering layer, respectively.

In an embodiment of the present disclosure, the shape of the filtering layer tapers upward, whereas the two connection elements are disposed at upper and lower edges of the filtering layer, respectively.

In an embodiment of the present disclosure, the base layer is made of at least one of woven fabric, paper, non-woven fabric, and filtering material.

In an embodiment of the present disclosure, the filtering layer is made of at least one of activated carbon, electrostatic adsorption material, and chemical filtering material .

In an embodiment of the present disclosure, the mask-oriented air filtering pad further comprises a water absorbing layer disposed on an inward side of the filtering layer.

The required area of the filtering layer is minimized, and the airtight seal tightly encloses the human mouth and nose; thus, the mask-oriented air filtering pad can save filtering materials, cut cost, reduce waste, enhance filtration, and allow the human face to feel comfortable. Furthermore, users no longer need to use a mask together with any ear-mounted face mask but can allow the mask-oriented air filtering pad to be directly coupled to the mask for use, so as to not only lessen the burden otherwise imposed on the human ears but also dispense with the use of ear-mounting wires.

### BRIEF DESCRIPTION OF THE DRAWINGS

FIG. 1A is a schematic view of the inner side of a mask-oriented air filtering pad according to the first embodiment of the present disclosure.

FIG. 1B is a schematic view of the outer side of the mask-oriented air filtering pad according to the first embodiment of the present disclosure.

FIG. 2 is a schematic view of the inner side of the mask-oriented air filtering pad according to the second embodiment of the present disclosure.

FIG. 3 is a schematic view of the inner side of the mask-oriented air filtering pad according to the third embodiment of the present disclosure.

FIG. 4 is a schematic view of a base layer neatly arranged.

FIG. 5 is a cross-sectional view of the mask-oriented air filtering pad according to the first embodiment of the present disclosure.

FIG. 6 is a schematic view of how to wear the mask-oriented air filtering pad according to the first embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

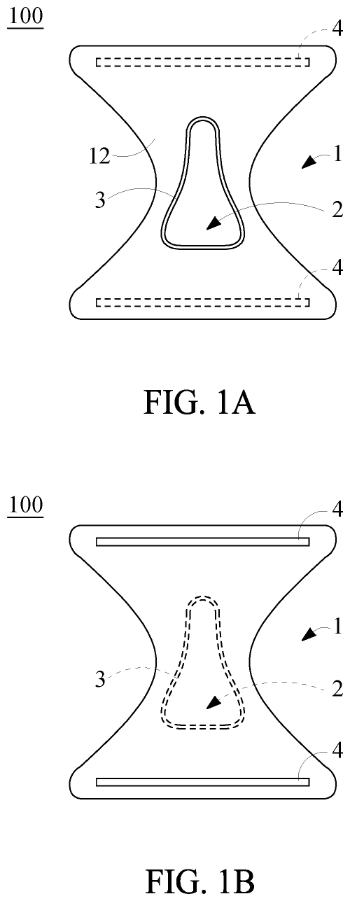

Referring to FIG. 1A and FIG. 1B, in the first embodiment of the present disclosure, a mask-oriented air filtering pad 100 comprises a base layer 1, a filtering layer 2, an airtight seal 3 and at least two connection elements 4.

The base layer 1 has an outer side 11 and an inner side 12. In this embodiment, the base layer 1 is made of at least one of woven fabric, paper, non-woven fabric and filtering material of different filtering grades. The purpose of the base layer 1 is to support the filtering layer 2; hence, the base layer 1 thus made is air-permeable and comfortable.

The filtering layer 2 is disposed at the middle of the inner side 12 and corresponds in outline to the human mouth and nose. In this embodiment, the filtering layer 2 is of the least area required to cover the human mouth and nose completely, and its shape tapers upward. However, the present disclosure is not limited thereto, as the filtering layer 2 may also be of any other geometrical shapes, such as isosceles triangle, to facilitate cutting. In this embodiment, the filtering layer 2 is made of at least one of activated carbon, electrostatic adsorption material and chemical filtering material. The mask-oriented air filtering pad 100 operates in conjunction with the filtering layer 2 which performs different functions and is of different grades, such as surgical face mask grade filtering material, N95 face mask grade filtering material, chemical filtering material dedicated to filtering out chemical toxins, and filtering material dedicated to filtering out dust particles; hence, users may select different types of said mask-oriented air filtering pad 100 as needed.

The airtight seal 3 surrounds the filtering layer 2 and is disposed on the inner side 12. The airtight seal 3 is, for example, made of airtight-grade sponge or silicone and adapted to seal the filtering layer 2. When the filtering layer 2 is attached to the human mouth and nose, it is feasible for the airtight seal 3, the filtering layer 2, and the human mouth and nose to jointly form a closed space conducive to enhancement of filtration.

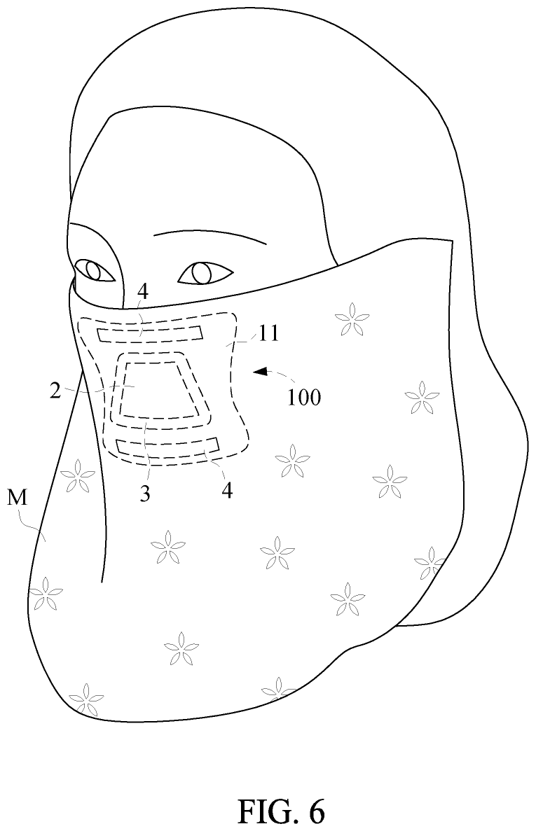

At least two connection elements 4 are disposed at two end portions on the outer side 11, respectively, to connect to a mask M. Referring to FIG. 6, when the filtering layer 2 faces the human mouth and nose, the outer side 11 of the base layer 1 is fixed to inner side of the mask M by the connection elements 4. The connection elements 4 comes in various structural forms, such as hangers, clasps, hooks (corresponding in position to related connection members of the mask M), and hook-and-loop fasteners. In this embodiment, the connection elements 4 are adhesive and capable of fixing the base layer 1 to the inner side of the mask M. The connection elements 4 are not necessarily disposed at the two end portions on the outer side 11. The connection elements 4 each loop (as shown in FIG. 3) or are provided in an appropriate number so as to be fixed to the base layer 1. The mask-oriented air filtering pad 100 is fully hidden on the inward side of the mask M or slightly exposed and bears colorful patterns to match the mask M.

Therefore, the mask-oriented air filtering pad 100 comprises the filtering layer 2 of the least required area and the airtight seal 3 tightly enclosing the human mouth and nose to save filtering materials, cut cost, reduce waste, enhance filtration, and render the mask M comfortable. Also, users no longer need to use the mask M together with any ear-mounted face mask but can allow the mask-oriented air filtering pad 100 to be directly coupled to the mask M for use, so as to not only lessen the burden otherwise imposed on the human ears but also dispense with the use of ear-mounting wires. The mask M is worn on the human face and may function as cosmetic veil, scarf, protective tool or decorative article.

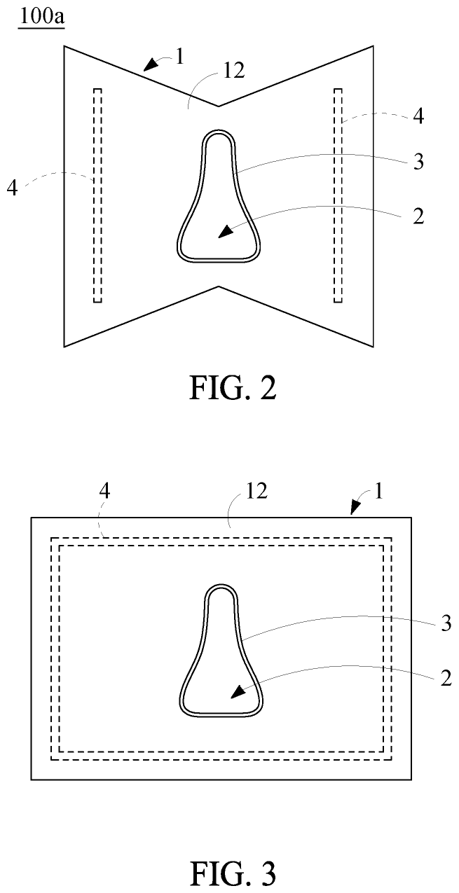

In the first embodiment of the present disclosure, as shown in FIG. 1A and FIG. 1B, the shape of the filtering layer 2 tapers upward, whereas the two connection elements 4 are disposed at upper and lower edges of the filtering layer 2, respectively. However, the present disclosure is not limited thereto, as shown in FIG. 2, in the second embodiment of the present disclosure, the mask-oriented air filtering pad 100a is characterized in that the two connection elements 4 are disposed at the left and right edges of the filtering layer 2, respectively.

In the first embodiment of the present disclosure, as shown in FIG. 1A and FIG. 1B, the distance between the two end portions of the base layer 1 is greater than the width of the middle part of the base layer 1, so as to minimize the required amount of the material for making the base layer 1 and enhance the anchoring capability of the connection elements 4. However, the present disclosure is not limited thereto, as shown in FIG. 3, in the third embodiment of the present disclosure, the mask-oriented air filtering pad 100b is characterized in that the base layer 1 is rectangular in shape, with the end portions equal in width to the middle part.

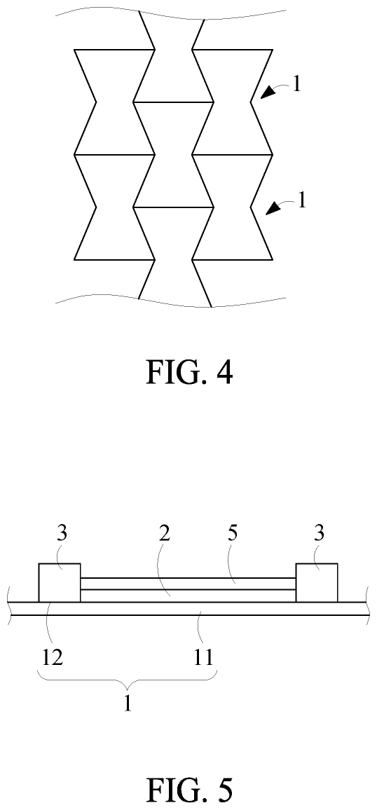

In the first embodiment of the present disclosure, as shown in FIG. 1A and FIG. 1B, the base layer 1 has a plurality of rounded corners. However, the present disclosure is not limited thereto, as shown in FIG. 2, the mask-oriented air filtering pad 100a has technical features as follows: the base layer 1 has linear outlines, and the distance between the two end portions decreases toward the middle by 50%. Thus, the base layer 1 is neatly arranged to the greatest extent as shown in FIG. 4, so as to cut production cost and reduce waste.

Referring to FIG. 5, the mask-oriented air filtering pad 100 further comprises a water absorbing layer 5 disposed on the inward side of the filtering layer 2. The water absorbing layer 5 is in direct contact with the human mouth and nose to absorb moisture from the human body, so as to preclude function loss of the filtering layer 2 and extend service life of the filtering layer 2.

While the present disclosure has been described by means of specific embodiments, numerous modifications and variations could be made thereto by those skilled in the art without departing from the scope and spirit of the present disclosure set forth in the claims.

What is claimed is:

1. A mask-oriented air filtering pad, comprising:
a base layer having an outer side and an inner side;
a filtering layer disposed at a middle of the inner side and corresponding in outline to the human mouth and nose;
an airtight seal surrounding the filtering layer and disposed on the inner side; and
at least two connection elements disposed at two end portions on the outer side, respectively.

2. The mask-oriented air filtering pad of claim 1, wherein a distance between the two end portions of the base layer is greater than a width of a middle part of the base layer.

3. The mask-oriented air filtering pad of claim 1, wherein the at least two connection elements are adhesive.

4. The mask-oriented air filtering pad of claim 1, wherein the shape of the filtering layer tapers upward, whereas the two connection elements are disposed at left and right edges of the filtering layer, respectively.

5. The mask-oriented air filtering pad of claim 1, wherein the shape of the filtering layer tapers upward, whereas the two connection elements are disposed at upper and lower edges of the filtering layer, respectively.

6. The mask-oriented air filtering pad of claim 1, wherein the base layer is made of at least one of woven fabric, paper, non-woven fabric, and filtering material.

7. The mask-oriented air filtering pad of claim 1, wherein the filtering layer is made of at least one of activated carbon, electrostatic adsorption material, and chemical filtering material.

8. The mask-oriented air filtering pad of claim 1, further comprising a water absorbing layer disposed on an inward side of the filtering layer.
